(19) United States
(12) Patent Application Publication
(10) Pub. No.: US 2018/0281087 A1
(43) Pub. Date: Oct. 4, 2018

(54) SYSTEM AND METHODOLOGY THAT FACILITATES A NON-CIRCULAR ARBOR DESIGN

(71) Applicant: JPL GLOBAL, LLC, Moreno Valley, CA (US)

(72) Inventor: Paul W. GUTH, Menifee, CA (US)

(21) Appl. No.: 15/937,826

(22) Filed: Mar. 27, 2018

Related U.S. Application Data
(60) Provisional application No. 62/477,398, filed on Mar. 27, 2017.

(51) Int. Cl. B23D 61/02; B27B 5/30

(52) U.S. Cl. CPC B23D 61/025; B27B 5/30

(57) ABSTRACT

Aspects of the disclosure relate to a non-circular arbor design. In one such aspect, an apparatus comprising a circular saw blade is disclosed. Within such embodiment, the circular saw blade includes a non-circular arbor hole that is compatible with at least a first arbor drive shaft and a second arbor drive shaft. Here, it is further contemplated that the first arbor drive shaft has a first shape matching the non-circular arbor hole, whereas the second arbor drive shaft has a second shape different than the non-circular arbor hole. In a further aspect, another apparatus directed towards a non-circular arbor design is disclosed. For this embodiment, the apparatus includes a non-circular arbor drive shaft that is only compatible with circular saw blades having a non-circular arbor hole shape that match a shape of the non-circular arbor drive shaft.

### CROSS-REFERENCE TO RELATED APPLICATIONS

The application claims priority to and the benefit of U.S. provisional patent application No. 62/477,398 filed on Mar. 27, 2017, the entire content of which is incorporated herein by reference as if fully set forth below in its entirety and for all applicable purposes.

### TECHNICAL FIELD

The subject disclosure generally relates to circular saw blades, and more specifically to a system and methodology that facilitates a non-circular arbor design.

### BACKGROUND

Circular saw blades are normally driven by rotating shafts connected to motors. For instance, as illustrated in FIGS. 1-2, a conventional circular saw blade 100 will typically include a circular arbor hole 110 for acceptance of a circular arbor drive shaft 200. In general, any circular arbor hole of a particular diameter is thus compatible with any circular arbor drive shaft with a corresponding diameter. As such, when a blade becomes worn on a power tool, a user simply replaces the old blade with a new blade. For warranty purposes, however, a power tool manufacturer may not want users to replace blades in their tools with generic blades. Nevertheless, those same power tool manufacturers may want their blades to be compatible with other power tools.

Accordingly, an arbor design that enables blades to be universally used by both standard and proprietary arbor drives is desirable. To this end, it should be noted that the above-described deficiencies are merely intended to provide an overview of some of the problems of conventional systems and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with a non-circular arbor design. In one such aspect, an apparatus comprising a circular saw blade is disclosed. Within such embodiment, the circular saw blade includes a non-circular arbor hole that is compatible with at least a first arbor drive shaft and a second arbor drive shaft. Here, it is further contemplated that the first arbor drive shaft has a first shape matching the non-circular arbor hole, whereas the second arbor drive shaft has a second shape different than the non-circular arbor hole. In a particular aspect of this embodiment, the second arbor drive shaft is a circular arbor drive shaft, whereas the non-circular arbor hole comprises at least two areas of contact compatible with the circular arbor drive shaft (e.g., where the at least two areas of contact are arc segments as illustrated in FIGS. 9 & 12).

In a further aspect, another apparatus directed towards a non-circular arbor design is disclosed. For this embodiment, the apparatus includes a non-circular arbor drive shaft that is only compatible with circular saw blades having a non-circular arbor hole shape that match a shape of the non-circular arbor drive shaft. In a particular aspect of this embodiment, the shape of the non-circular arbor drive shaft includes at least one notch (See e.g., FIGS. 10 & 13), which is configured to prevent the non-circular arbor drive shaft from mating with a circular saw blade having a circular arbor hole.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates a conventional circular saw blade;

FIG. 2 illustrates a front and perspective view of a conventional arbor drive shaft compatible with the circular saw blade illustrated in FIG. 1;

FIG. 3 is a top, right perspective view of an exemplary circular saw blade in accordance with an aspect of the subject specification;

FIG. 4 is a top, left perspective view of the circular saw blade of FIG. 3;

FIG. 5 is a first side elevation view of the circular saw blade of FIG. 3;

FIG. 6 is a second side elevation view of the circular saw blade of FIG. 3;

FIG. 7 illustrates a front and perspective view of an exemplary non-circular arbor drive shaft in accordance with an aspect of the subject specification;

FIG. 8 illustrates an exemplary non-circular arbor drive shaft mating with an exemplary matching non-circular arbor hole in accordance with an aspect of the subject specification;

FIG. 9 illustrates a conventional circular arbor drive shaft mating with an exemplary non-circular arbor hole in accordance with an aspect of the subject specification;

FIG. 10 illustrates the incompatibility of an exemplary non-circular arbor drive shaft with a conventional circular arbor hole in accordance with an aspect of the subject specification;

FIG. 11 illustrates an exemplary non-circular arbor drive shaft mating with an exemplary matching non-circular arbor hole in accordance with an aspect of the subject specification;

FIG. 12 illustrates a conventional circular arbor drive shaft mating with an exemplary non-circular arbor hole in accordance with an aspect of the subject specification;

FIG. 13 illustrates the incompatibility of an exemplary non-circular arbor drive shaft with a conventional circular arbor hole in accordance with an aspect of the subject specification;

FIGS. 14-17 are schematic diagrams of a circular saw blade in accordance with a first exemplary embodiment of the subject specification; and

FIGS. 18-22 are schematic diagrams of a circular saw blade in accordance with a second exemplary embodiment of the subject specification.

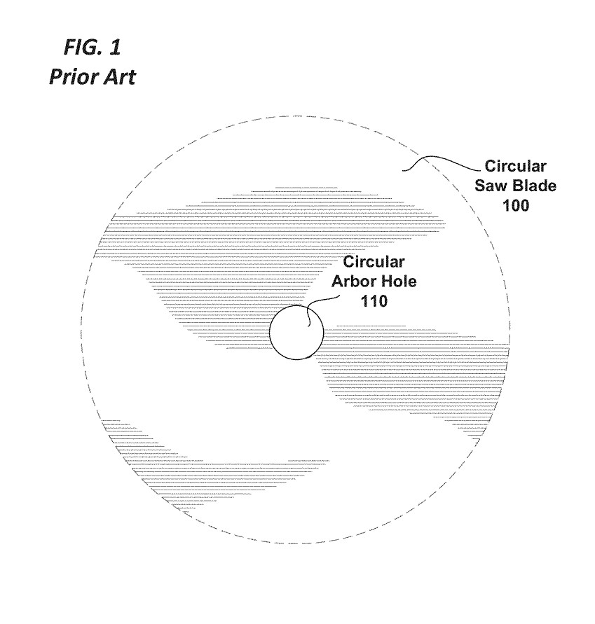

### DETAILED DESCRIPTION

The various embodiments disclosed herein are directed towards a universal non-circular arbor design. To this end, it is noted that standard arbor designs comprise mating a one-inch circular arbor drive shaft into a one-inch circular arbor hole.

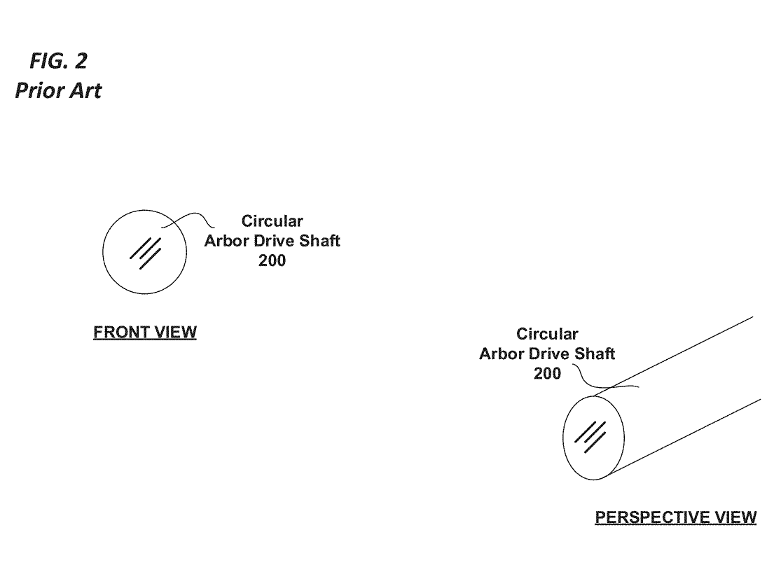

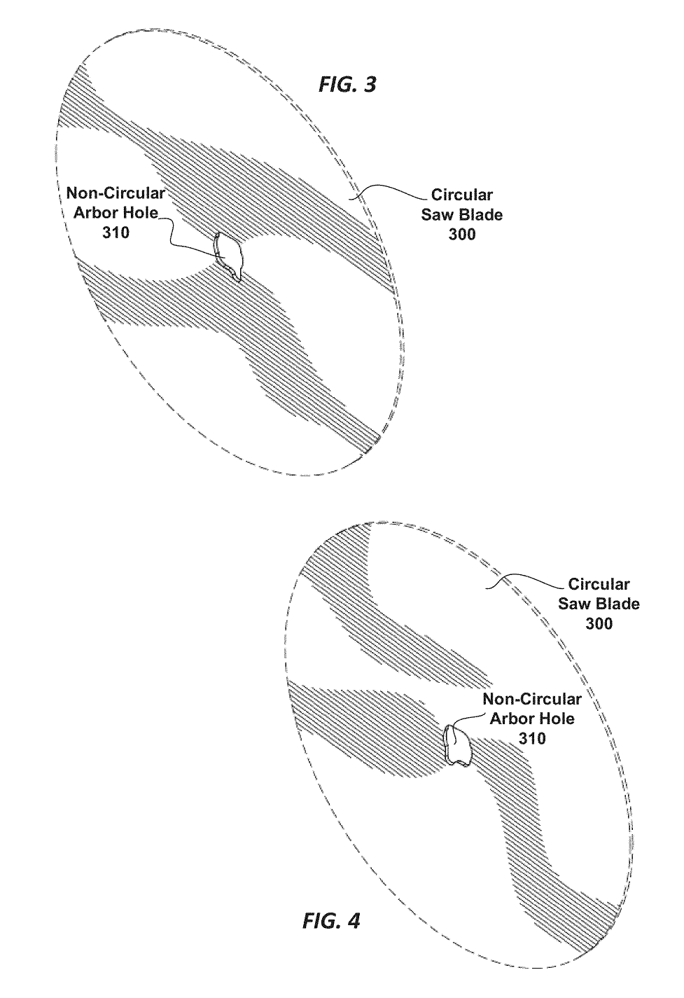

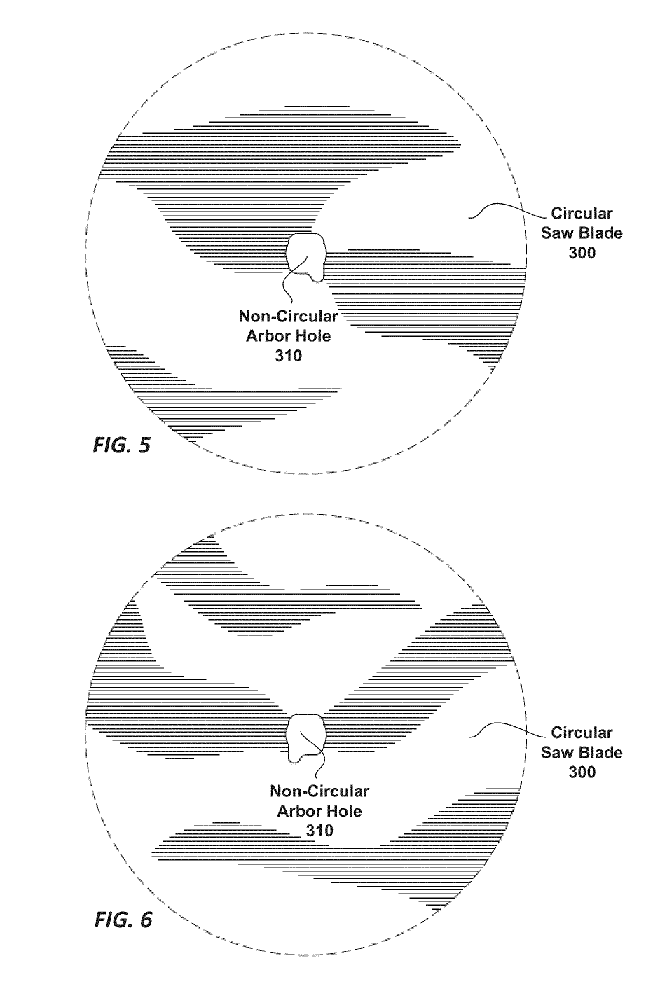

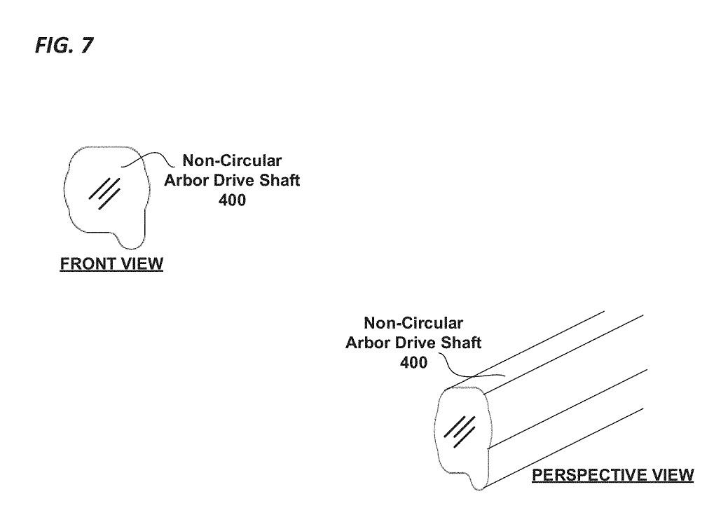

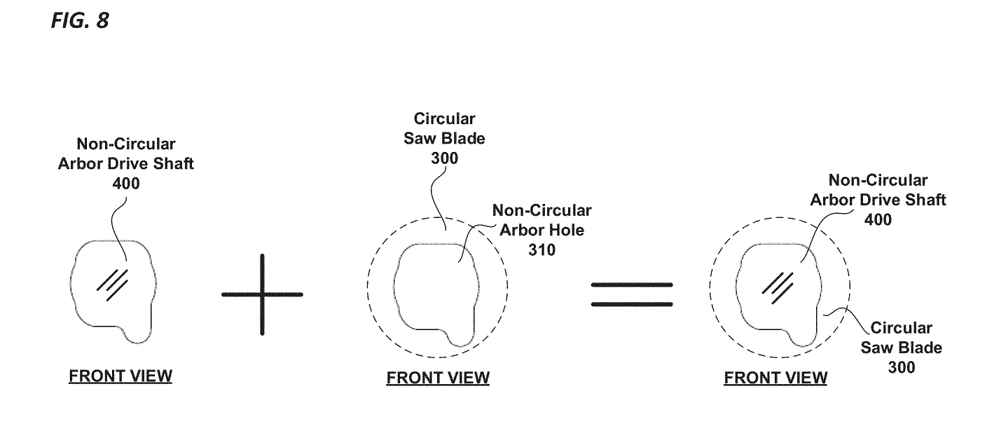

In a first aspect of the disclosure, a circular saw blade with a non-circular arbor hole is contemplated, wherein the non-circular arbor hole is compatible with a standard one-inch circular arbor drive. For instance, as illustrated in FIGS. 3-6, a circular saw blade 300 comprising a non-circular arbor hole 310 is disclosed, wherein the non-circular arbor hole 310 is configured to be driven by either a conventional circular arbor drive shaft (See e.g., the circular arbor drive shaft 200 illustrated in FIG. 2), or a matching non-circular arbor drive shaft (See e.g., the non-circular arbor drive shaft 400 illustrated in FIG. 7) in accordance with aspects disclosed herein.

Referring next to FIG. 8, an illustration is provided of an exemplary non-circular arbor drive shaft mating with an exemplary matching non-circular arbor hole in accordance with an aspect of the subject specification. Here, because the shape of non-circular arbor drive shaft 400 matches with the shape of non-circular arbor hole 310, non-circular arbor drive shaft 400 may be inserted into non-circular arbor hole 310 in a manner that allows non-circular arbor drive shaft 400 to rotate circular saw blade 300.

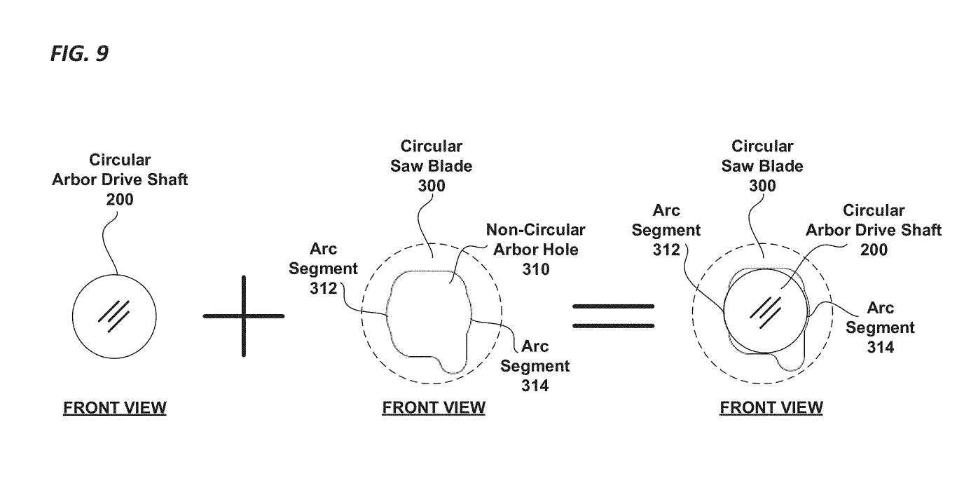

Referring next to FIG. 9, an illustration is provided of a conventional circular arbor drive shaft mating with an exemplary non-circular arbor hole in accordance with an aspect of the subject specification. Here, although the shape of circular arbor drive shaft 200 does not match with the shape of non-circular arbor hole 310, the dimensions of non-circular arbor hole 310 are selected so that circular arbor drive shaft 200 may nonetheless be inserted into non-circular arbor hole 310. Namely, it is contemplated that the dimensions of non-circular arbor hole 310 are selected so that circular arbor drive shaft 200 is insertable into non-circular arbor hole 310 in a manner that allows circular arbor drive shaft 200 to rotate circular saw blade 300. For instance, as illustrated, non-circular arbor hole 310 may be configured to include arc segments 312 and 314, wherein arc segments 312 and 314 are the primary points of contact between circular arbor drive shaft 200 and circular saw blade 300. In a particular aspect of the disclosure, even if arc segments 312 and 314 are the only points of contact with circular arbor drive shaft 200, it is contemplated that such contact would be sufficient for circular arbor drive shaft 200 to rotate circular saw blade 300.

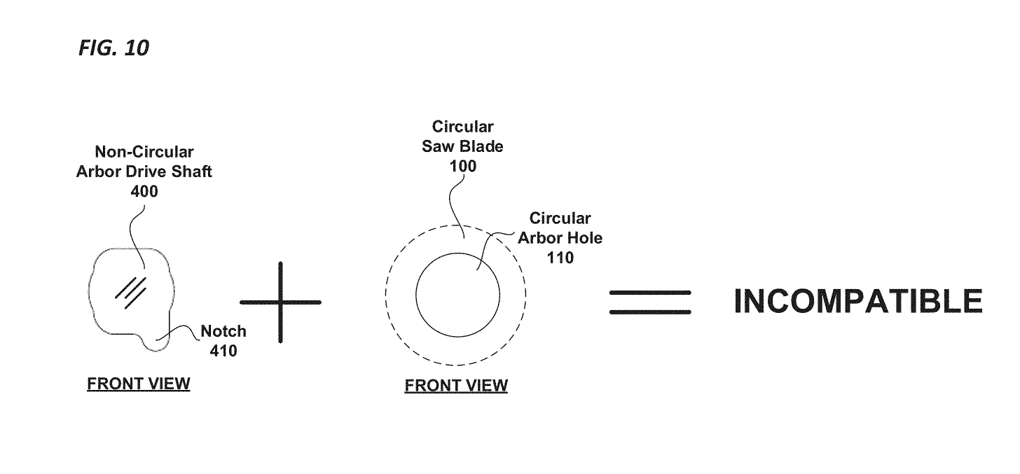

In another aspect of the disclosure, a non-circular arbor drive is contemplated, wherein the non-circular arbor drive is only compatible with similarly shaped non-circular arbor holes. For instance, as illustrated in FIG. 10, because non-circular arbor drive shaft 400 cannot mate with circular arbor hole 110, non-circular arbor drive shaft 400 is incompatible with circular saw blade 100. To accommodate such incompatibility, it is contemplated that non-circular arbor drive shaft 400 may be configured to include notch 410, as shown. Within such embodiment, the dimensions of non-circular arbor drive shaft 400 are selected such that notch 410 is placed at a radius that exceeds the radius of circular arbor hole 110 (e.g., where conventional circular arbor holes have a one-inch diameter), so that notch 410 prevents non-circular arbor drive shaft 400 from fitting through circular arbor hole 110. Replacing saw blades in a saw tool comprising non-circular arbor drive shaft 400 would thus require the user to replace the saw blade with a saw blade having a matching non-circular arbor hole 310. Moreover, the design of non-circular arbor drive shaft 400 desirably prevents users from replacing a saw blade having a matching non-circular arbor hole 310 with a saw blade having a conventional one-inch circular arbor hole (e.g., circular arbor hole 110).

As previously stated, however, it contemplated that circular saw blade 300 is configured to be driven by either a conventional circular arbor drive shaft (See e.g., FIG. 9), or a matching non-circular arbor drive shaft (See e.g., FIG. 8) in accordance with aspects disclosed herein. A user replacing saw blades in a saw tool comprising a conventional arbor drive shaft (e.g., circular arbor drive shaft 200 illustrated in FIG. 2) may thus replace such saw blades with either a saw blade having a conventional circular arbor hole (e.g., circular saw blade 100), or a saw blade having a non-circular arbor hole in accordance with the aspects disclosed herein (e.g., circular saw blade 300).

Here, although the non-circular arbor hole 310 of circular saw blade 300 is Q-shaped, it is contemplated that any non-circular arbor hole shape may be used in which such non-circular arbor hole shape may be driven by either a conventional circular arbor drive shaft (e.g., circular arbor drive shaft 200), or a matching non-circular arbor drive shaft in accordance with aspects disclosed herein.

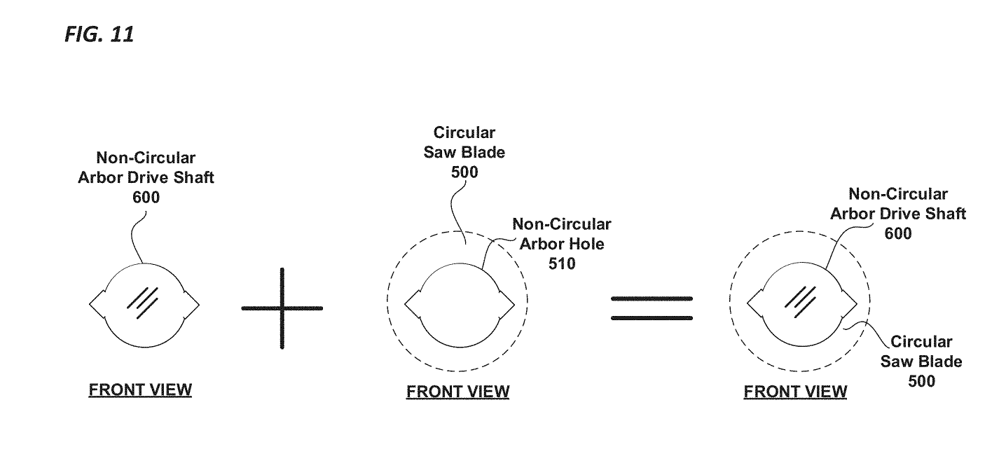

For instance, referring next to FIG. 11, an illustration is provided of another exemplary non-circular arbor drive shaft mating with an exemplary matching non-circular arbor hole in accordance with an aspect of the subject specification. Here, because the shape of non-circular arbor drive shaft 600 matches with the shape of non-circular arbor hole 510, non-circular arbor drive shaft 600 may be inserted into non-circular arbor hole 510 in a manner that allows non-circular arbor drive shaft 600 to rotate circular saw blade 500.

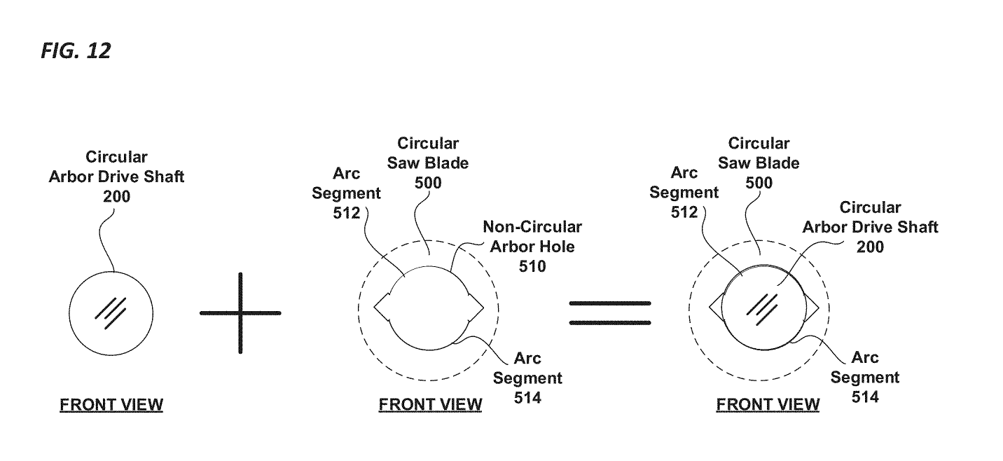

Referring next to FIG. 12, an illustration is provided of a conventional circular arbor drive shaft mating with the exemplary non-circular arbor hole illustrated in FIG. 11. Here, although the shape of circular arbor drive shaft 200 does not match with the shape of non-circular arbor hole 510, the dimensions of non-circular arbor hole 510 are selected so that circular arbor drive shaft 200 may nonetheless be inserted into non-circular arbor hole 510. Namely, it is contemplated that the dimensions of non-circular arbor hole 510 are selected so that circular arbor drive shaft 200 is insertable into non-circular arbor hole 510 in a manner that allows circular arbor drive shaft 200 to rotate circular saw blade 500. For instance, as illustrated, non-circular arbor hole 510 may be configured to include arc segments 512 and 514, wherein arc segments 512 and 514 are the primary points of contact between circular arbor drive shaft 200 and circular saw blade 500. In a particular aspect of the disclosure, even if arc segments 512 and 514 are the only points of contact with circular arbor drive shaft 200, it is contemplated that such contact would be sufficient for circular arbor drive shaft 200 to rotate circular saw blade 500.

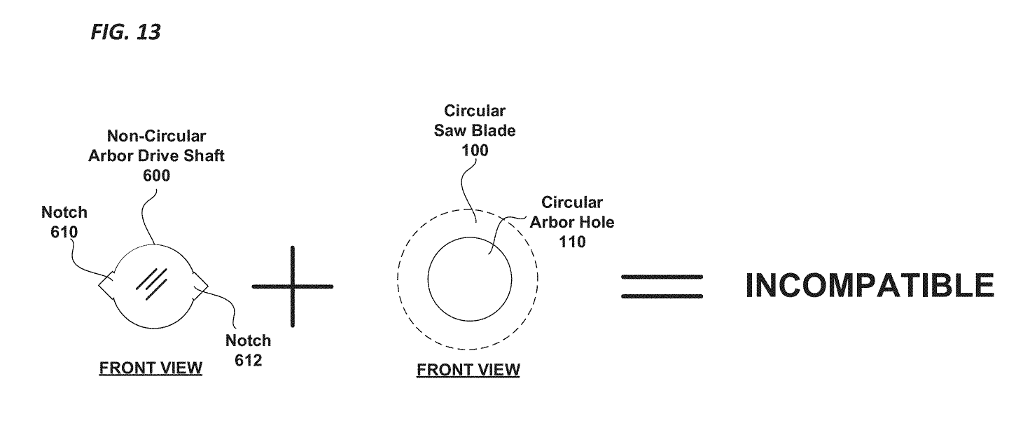

In another aspect of the disclosure, it is contemplated that non-circular arbor drive 600 may be configured to only be compatible with similarly shaped non-circular arbor holes 510. For instance, as illustrated in FIG. 13, because non-circular arbor drive shaft 600 cannot mate with circular arbor hole 110, non-circular arbor drive shaft 600 is incompatible with circular saw blade 100. To accommodate such incompatibility, it is contemplated that non-circular arbor drive shaft 600 may be configured to include notches 610 and 612, as shown. Within such embodiment, the dimensions of non-circular arbor drive shaft 600 are selected such that notches 610 and 612 are placed at a radius that exceeds the radius of circular arbor hole 110 (e.g., where conventional circular arbor holes have a one-inch diameter), so that notches 610 and 612 prevent non-circular arbor drive shaft 600 from fitting through circular arbor hole 110. Replacing saw blades in a saw tool comprising non-circular arbor drive shaft 600 would thus require the user to replace the saw blade with a saw blade having a matching non-circular arbor hole 510. Moreover, the design of non-circular arbor drive shaft 600 desirably prevents users from replacing a saw blade having a matching non-circular arbor hole 510 with a saw blade having a conventional one-inch circular arbor hole (e.g., circular arbor hole 110).

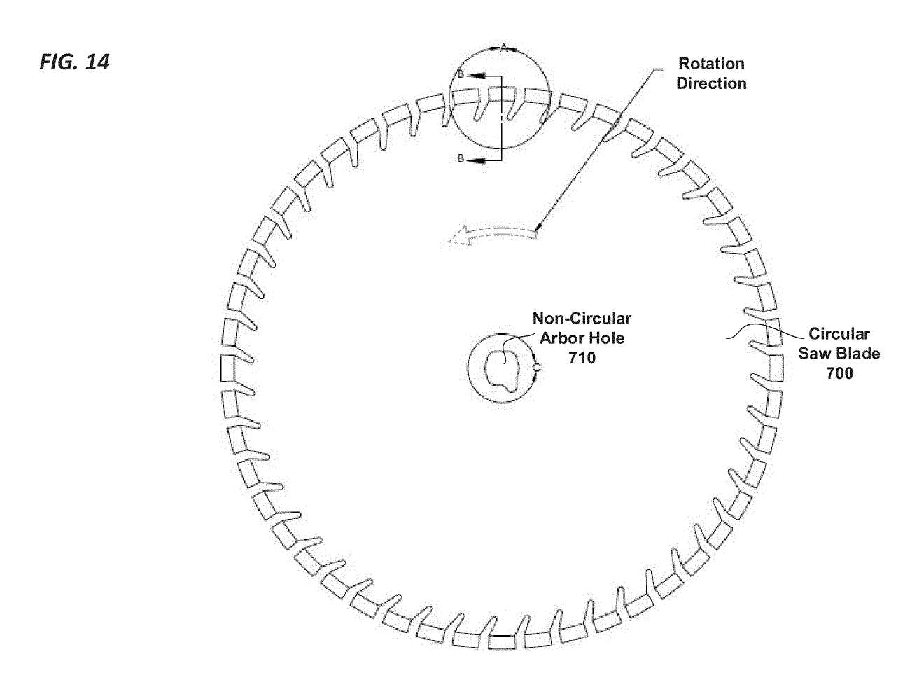

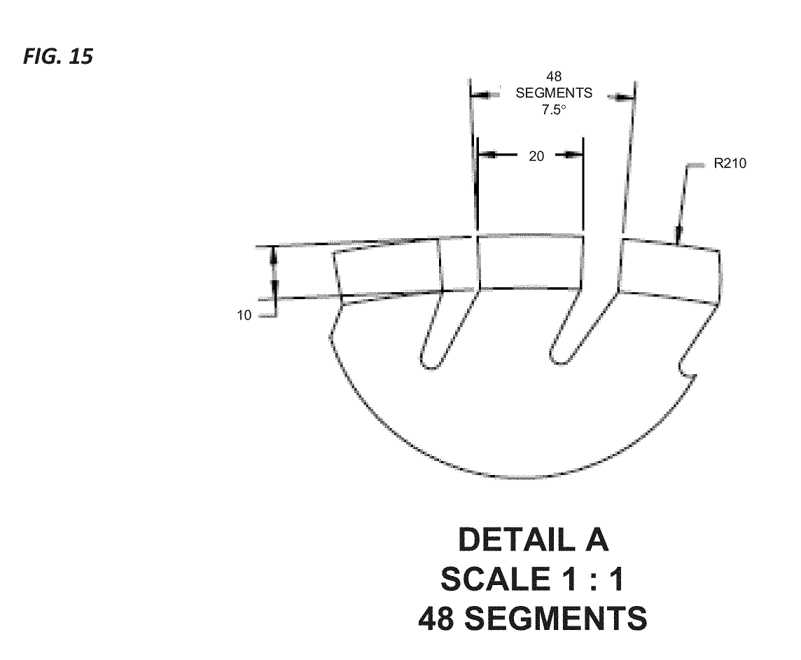

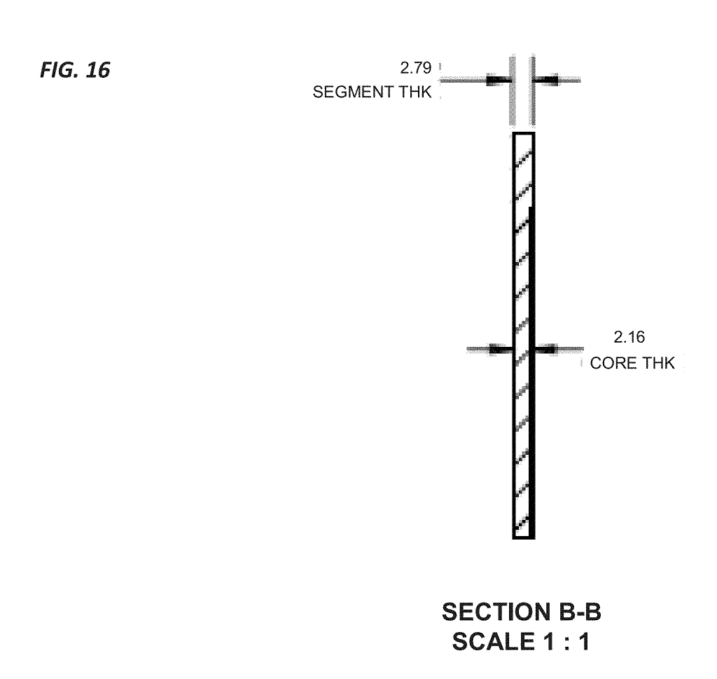

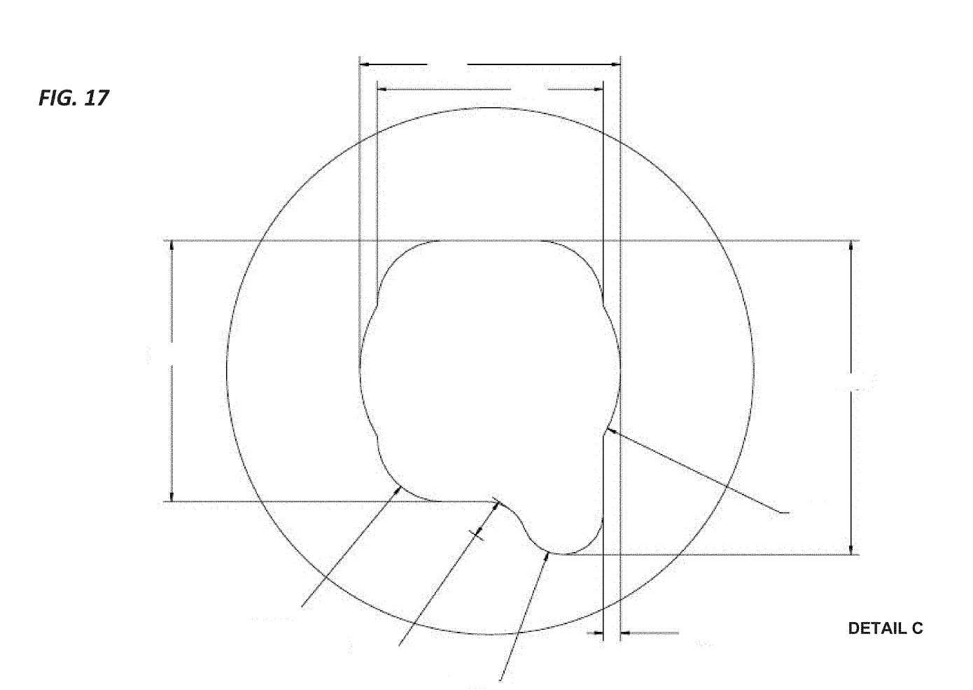

Referring next to FIGS. 14-17 schematic diagrams of a circular saw blade are provided in accordance with a first exemplary embodiment of the subject specification. For this particular embodiment, circular saw blade 700 comprises non-circular arbor hole 710, wherein circular saw blade 700 has a diameter of 16.5 inches (i.e., 420 millimeters), and wherein all illustrated dimensions correspond to inches.

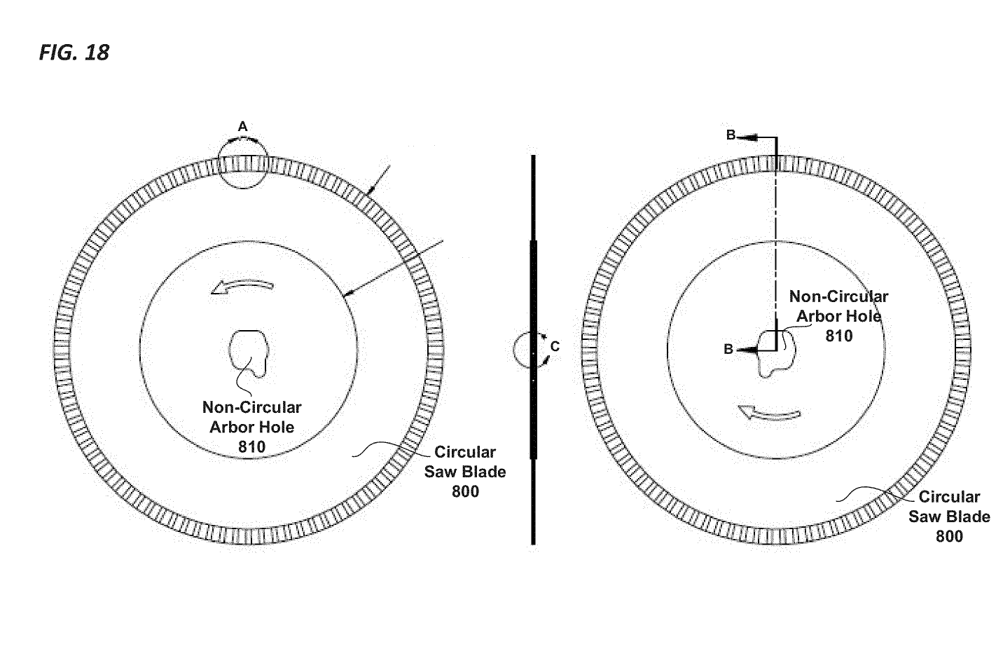

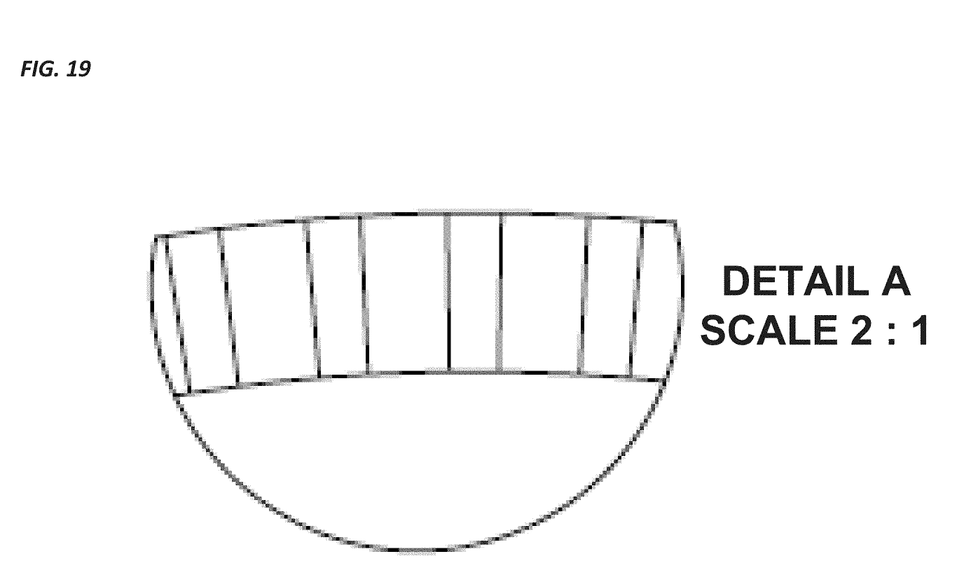

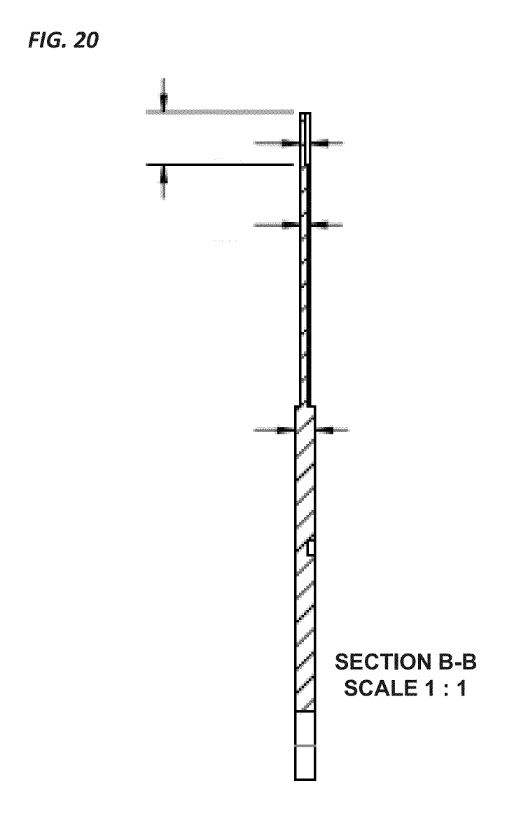

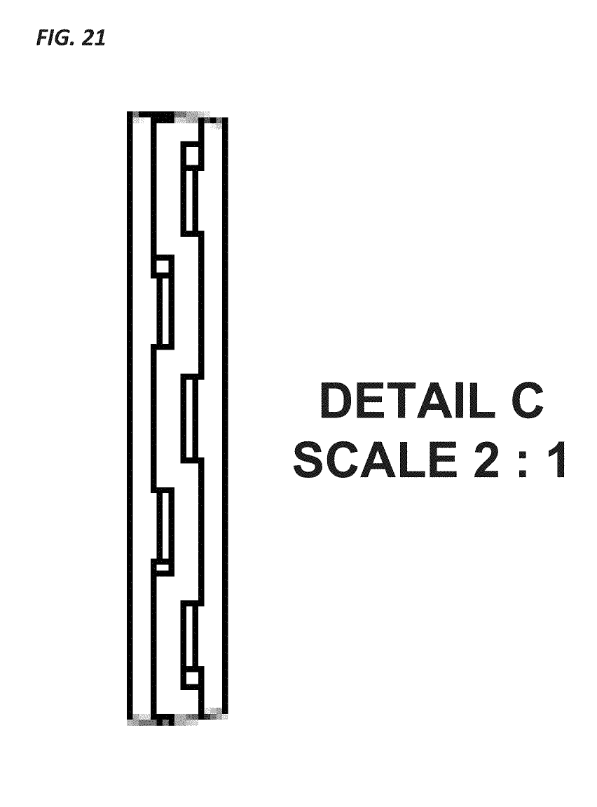

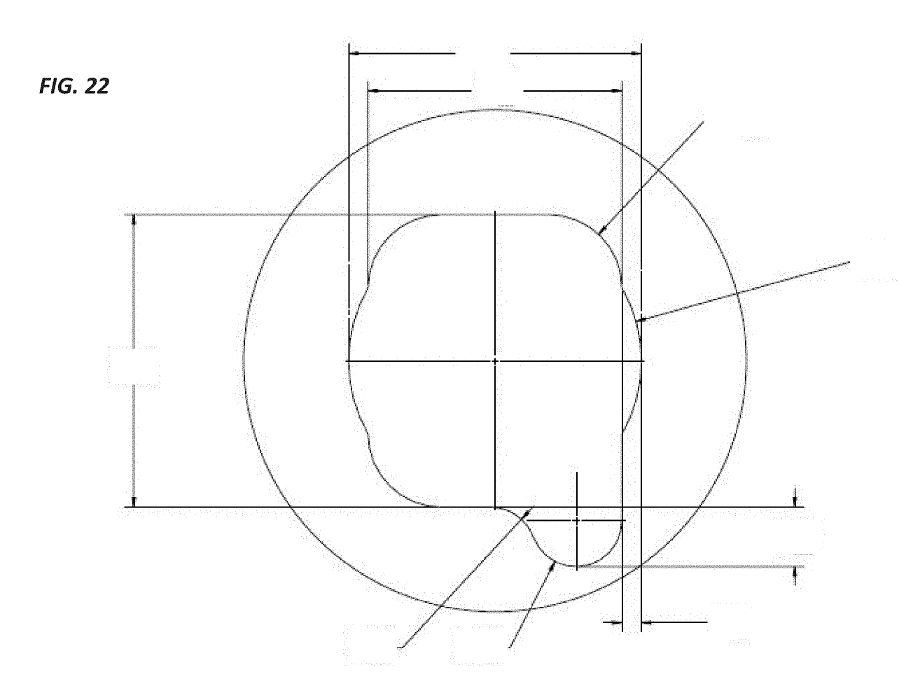

Referring next to FIGS. 18-22 schematic diagrams of a circular saw blade are provided in accordance with a second exemplary embodiment of the subject specification. For this particular embodiment, circular saw blade 800 comprises non-circular arbor hole 810, wherein circular saw blade 800 is a ten-inch multi-material tile blade, and wherein all illustrated dimensions again correspond to inches.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components coupled to other components rather than included within parent components (hierarchical). Additionally, it is noted that one or more components may be combined into a single component providing aggregate functionality or divided into several separate sub-components, and any one or more middle layers may be provided to couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

While the various embodiments have been described in connection with the exemplary embodiments of the various figures, it is to be understood that other similar embodiments may be used or modifications and additions may be made to the described embodiment for performing the same function without deviating there from. Therefore, the present invention should not be limited to any single embodiment.

1. An apparatus comprising:
a circular saw blade that includes a non-circular arbor hole, wherein the non-circular arbor hole is compatible with at least a first arbor drive shaft and a second arbor drive shaft, the first arbor drive shaft having a first shape matching the non-circular arbor hole, and the second arbor drive shaft having a second shape different than the non-circular arbor hole.

2. The apparatus of claim 1, wherein the second arbor drive shaft is a circular arbor drive shaft, and wherein the non-circular arbor hole comprises at least two areas of contact compatible with the circular arbor drive shaft.

3. The apparatus of claim 2, wherein the at least two areas of contact are arc segments.

4. An apparatus comprising:
a non-circular arbor drive shaft, wherein the non-circular arbor drive shaft is only compatible with circular saw blades having a non-circular arbor hole shape that matches a shape of the non-circular arbor drive shaft.

5. The apparatus of claim 4, wherein the shape of the non-circular arbor drive shaft includes at least one notch.
